(19) United States
(12) Patent Application Publication
(10) Pub. No.: US 2006/0011213 A1
(43) Pub. Date: Jan. 19, 2006

(54) Substrate transfer device and cleaning method thereof and substrate processing system and cleaning method thereof

(75) Inventors: Tsuyoshi Moriya, Nirasaki-shi (JP); Hiroyuki Nakayama, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/115,357

(22) Filed: Apr. 27, 2005

Related U.S. Application Data
(60) Provisional application No. 60/589,807, filed on Jul. 22, 2004.

(30) Foreign Application Priority Data
Apr. 28, 2004 (JP) 2004-134175

(51) Int. Cl. B08B 6/00; B08B 9/00

(52) U.S. Cl. 134/1.1; 118/715; 134/22.1

(57) ABSTRACT

A substrate transfer device includes an accommodating chamber for accommodating a substrate; a substrate transfer unit installed in the accommodating chamber for transferring the substrate; a gas exhaust unit for exhausting the accommodating chamber; and a gas introducing unit for introducing a gas into the accommodating chamber. The substrate transfer unit has a mounting subunit for mounting the substrate thereon, an arm subunit one end of which is connected to the mounting subunit to move the mounting subunit, and an electrode installed in the mounting subunit to which a voltage is applied, and a high voltage is applied to the electrode while the gas is being introduced into the accommodating chamber and the accommodating chamber is being exhausted.

### FIELD OF THE INVENTION

The present invention relates to a substrate transfer device and a cleaning method thereof, and a substrate processing system and a cleaning method thereof; and, more particularly, to a substrate transfer device and a cleaning method thereof and a substrate processing system and a cleaning method thereof for cleaning an inside of the substrate transfer device without exposing it to the air.

### BACKGROUND OF THE INVENTION

Conventionally, among substrate processing systems for performing various kinds of plasma processing such as ion-doping, film-forming and etching on a wafer, there is known a clustered substrate processing system, in which a plurality of substrate processing apparatuses are radially arranged and have a substrate transfer chamber in common among them.

This clustered substrate processing system includes, e.g., as shown in FIG. 6A, two substrate processing apparatuses 61; a loader module 62 for transferring a substrate from a wafer cassette (not shown); two wafer loading/unloading chambers 63 for loading/unloading a wafer to/from the loader module 62; and a substrate transfer chamber 64, which is a vacuum chamber, interposed between the substrate processing apparatus 61 and the wafer loading/unloading chamber 63 (for example, see Reference 1).

The substrate transfer chamber 64 has therein, as shown in FIG. 6B, a gas inlet unit 65 for purging, e.g., an N₂ gas from the inside thereof, and a pump unit 66 for vacuum pumping the inside thereof. Further, it has therein a handling device 67 for transferring the wafer, and in addition, it has gate valves 68 which can be opened and closed on sides respectively making contacts with the substrate processing apparatus 61 and the wafer loading/unloading chamber 63. The handling device 67, which is a Scara arm type handling device having a plurality of arm members and a rotatable table, transfers the wafer to the substrate processing apparatus 61 or the wafer loading/unloading chamber 63 via the gate valve 68.

When wafers are continually processed in this clustered substrate processing system, the particles adhered to a wafer and transferred into the substrate transfer chamber 64 or the particles which are cutting powder generated during an operation of the handling device 67 are deposited in the substrate transfer chamber 64. These deposited particles are floated by a gas flow generated while either purging the N₂ gas from the substrate transfer chamber 64 or vacuum pumping the substrate transfer chamber 64 and are adhered to a wafer, thereby reducing the wafer yield. Therefore, the particles deposited in the substrate transfer chamber 64 have to be removed. Conventionally, when the particles deposited in the substrate transfer chamber 64 are to be removed, a worker clean the substrate transfer chamber 64 by using, e.g., a cloth moistened with ethyl alcohol or the like.

(Reference 1) Japanese Patent Laid-open Application No. H10-154739 (FIG. 1)

However, when the worker clean the substrate transfer chamber 64 with the cloth or the like, its maintenance window (not shown) is opened to the outer environment (not shown), and thus dust in the air can be introduced into the substrate transfer chamber 64 in the form of particles, making it difficult to completely remove the particles deposited in the substrate transfer chamber 64. Further, since after cleaning the substrate transfer chamber 64, the chamber 64 has to be exhausted to vacuum and seasoned before receiving a wafer, the operation efficiency of the substrate processing system will be deteriorated.

### SUMMARY OF THE INVENTION

It is an object of the present invention to provide a substrate transfer device and a cleaning method thereof and a substrate processing system and a cleaning method thereof capable of adequately removing deposited particles without reducing the operating rate of the substrate processing system.

To achieve the object, in accordance with one aspect of the present invention, there is provided a substrate transfer device, comprising: an accommodating chamber for accommodating a substrate; a substrate transfer unit installed in the accommodating chamber for transferring the substrate; a gas exhaust unit for exhausting the accommodating chamber; and a gas introducing unit for introducing a gas into the accommodating chamber, wherein the substrate transfer unit has a mounting subunit for mounting the substrate thereon, an arm subunit one end of which is connected to the mounting subunit to move the mounting subunit, and an electrode installed in the mounting subunit to which a voltage is applied, and wherein a high voltage is applied to the electrode while the gas is being introduced into the accommodating chamber and the accommodating chamber is being exhausted.

In accordance with the substrate transfer device, since the substrate transfer unit has a mounting subunit for mounting the substrate thereon and an arm subunit one end of which is connected to the mounting subunit to move the mounting subunit, the mounting unit can be moved to a desired position in the accommodating chamber. Further, a high voltage is applied to the electrode while the gas is being introduced into the accommodating chamber and the accommodating chamber is being exhausted, so that a gas flow is formed in the accommodating chamber and an electrostatic stress is applied to a place near the desired position in the accommodating chamber. Thus, impurities deposited on the inner surface of the accommodating chamber are detached therefrom, and the detached impurities are discharged from the accommodating chamber by the gas flow. Therefore, the deposited impurities can be removed without exposing the accommodating chamber to the outer environment. That is, the deposited impurities can be removed sufficiently without reducing the operating rate of the substrate processing system including the substrate transfer device.

Preferably, the electrode is arranged in a manner to face the substrate mounted on the mounting subunit.

In the substrate transfer device, since the electrode is arranged in a manner to face the substrate mounted on the mounting subunit, an electrostatic stress is applied to detach impurities attached to the substrate. The detached impurities are discharged from the accommodating chamber by the gas flow, thereby cleaning the substrate.

Preferably, the magnitude of the high voltage ranges between 1 to 5 kV inclusive.

In the substrate transfer device, since the magnitude of the high voltage ranges between 1 to 5 kV inclusive, the electrostatic stress acting on the inner surface of the accommodating chamber can be increased, so that the impurities can be ensured to be detached.

Preferably, high voltages of different polarities are alternately applied to the electrode.

In the substrate transfer device, since the high voltages of different polarities are alternately applied to the electrode, the inner surface of the accommodating chamber can be prevented from being electrically charged. If the inner surface of the accommodating chamber is electrically charged, the electrostatic stress acting on the inner surface of the accommodating chamber is decreased, resulting in a decrease of the efficiency of removing the impurities. Therefore, by preventing the inner surface of the accommodating chamber from being electrically charged, the efficiency for removing the impurities deposited on the inner surface of the accommodating chamber can be prevented from being reduced.

Preferably, a pressure in the accommodating chamber is kept at 133 Pa or above.

In accordance with the substrate transfer device, since the pressure in the accommodating chamber is kept at 133 Pa or above, a viscous flow of a great viscous force can be formed in the accommodating chamber. The impurities detached from the inner surface of the accommodating chamber are absorbed by the viscous flow and discharged from the accommodating chamber. Therefore, the impurities deposited on the inner surface of the chamber are ensured to be removed.

To achieve the object, in accordance with another aspect of the present invention, there is provided a cleaning method of a substrate transfer device for removing particles deposited on an inner surface of the accommodating chamber for accommodating a substrate in the substrate transfer device, comprising: the moving step of moving the a mounting unit for mounting thereon the substrate to a desired position in the accommodating chamber; and the high voltage applying step of applying a high voltage to an electrode installed in the mounting unit having been moved, while a gas is being introduced into the accommodating chamber and the accommodating chamber is being exhausted.

In accordance with the cleaning method of the substrate transfer device, since the high voltage is applied to the electrode installed in the mounting unit having been moved while the gas is being introduced into the accommodating chamber and the accommodating chamber is being exhausted, a gas flow is formed in the accommodating chamber and an electrostatic stress is applied to a place near the desired position in the accommodating chamber. Thus, impurities deposited on the inner surface of the accommodating chamber are detached therefrom, and the detached impurities are discharged from the accommodating chamber by the gas flow. Therefore, the deposited impurities can be removed without exposing the accommodating chamber to the outer environment. That is, the deposited impurities can be removed sufficiently without reducing the operating rate of the substrate processing system including the substrate transfer device.

To achieve the object, in accordance with still another aspect of the present invention, there is provided a substrate processing system, comprising: a substrate transfer device including a first accommodating chamber for accommodating a substrate and a substrate transfer unit installed in the first accommodating chamber for transferring the substrate; and a substrate processing apparatus including a second accommodating chamber connected to the substrate transfer device for accommodating the substrate, wherein the substrate processing system further comprises: a gas exhaust unit for exhausting at least one of the first and the second accommodating chamber; and a gas introduction unit for introducing a gas or gases into the exhausted one of the accommodating chambers or both of the exhausted accommodating chambers, wherein the substrate transfer unit has a mounting subunit for mounting the substrate thereon, an arm subunit one end of which is connected to the mounting subunit to move the mounting subunit, and an electrode installed in the mounting subunit to which a voltage is applied, and wherein a high voltage is applied to the electrode while the gas is being introduced into one of the first and the second accommodating chambers in which the mounting unit has been moved and the accommodating chambers is being exhausted.

In accordance with the substrate processing system, since the substrate transfer unit has a mounting subunit for mounting the substrate thereon and an arm subunit one end of which is connected to the mounting subunit to move the mounting subunit, the mounting unit can be moved to a desired position in one of the first and the second accommodating chambers. Further, a high voltage is applied to the electrode while the gas is being introduced into the accommodating chamber and the accommodating chamber is being exhausted, so that a gas flow is formed in the accommodating chamber and an electrostatic stress is applied to a place near the desired position in the accommodating chamber. Thus, impurities deposited on the inner surface of the accommodating chamber are detached therefrom, and the detached impurities are discharged from the accommodating chamber by the gas flow. Therefore, the deposited impurities can be removed without exposing the first and the second accommodating chambers to the outer environment. That is, the deposited impurities can be removed sufficiently without reducing the operating rate of the substrate processing system including the substrate transfer device.

To achieve the object, in accordance with still another aspect of the present invention, there is provided a cleaning method of substrate processing system for removing particles deposited on an inner surface of the accommodating chamber or the accommodating chambers for accommodating a substrate in at least one of a substrate transfer device and a substrate processing apparatus included in the substrate processing system, comprising: the moving step of moving the a mounting unit for mounting thereon the substrate to a desired position in the accommodating chamber or the accommodating chambers in at least one of the substrate transfer device and the substrate processing apparatus; and the high voltage applying step of applying a high voltage to an electrode installed in the mounting unit having been moved, while a gas is being introduced into the accommodating chamber and the accommodating chamber is being exhausted.

In accordance with the substrate processing system, since the high voltage is applied to the electrode installed in the mounting unit having been moved while the gas is being introduced into the accommodating chamber in which the mounting unit has been moved and the accommodating chamber is being exhausted, a gas flow is formed in the accommodating chamber in which the mounting unit has been moved and an electrostatic stress is applied to a place near the desired position in the accommodating chamber. Thus, impurities having been deposited on the inner surface of the accommodating chamber are detached therefrom, and the detached impurities are discharged from the accommodating chamber by the gas flow. Therefore, the deposited impurities can be removed without exposing either one of the accommodating chambers in the substrate transfer device and the substrate processing apparatus to the outer environment. That is, the deposited impurities can be removed sufficiently without reducing the operating rate of the substrate processing system including the substrate transfer device.

### BRIEF DESCRIPTION OF THE DRAWINGS

The above and other objects and features of the present invention will become apparent from the following description of preferred embodiments, given in conjunction with the accompanying drawings, in which:

FIG. 1 shows a cross sectional view illustrating a schematic configuration of a substrate transfer device in accordance with a preferred embodiment of the present invention;

FIG. 2 presents a perspective view depicting a schematic configuration of a transfer arm of the substrate transfer device shown in the FIG. 1;

FIG. 3 provides a cross sectional view representing a schematic configuration of a substrate processing system in accordance with a preferred embodiment of the present invention;

FIG. 4 offers a flow chart for an evaluation sequence of a particle removing process carried out as an experimental example in accordance with the present invention;

FIG. 5 illustrates a graph representing a transition in PWP measured after the substrate transfer device was cleaned several times by employing the cleaning method in accordance with a preferred embodiment of the present invention; and

FIGS. 6A and 6B depict a schematic configuration of the conventional clustered substrate processing system equipped with a Scara arm type handling device, wherein FIG. 6A presents a horizontal sectional view of the clustered substrate processing system and FIG. 6B provides a sectional view along the line VI-VI in FIG. 6A.

### DETAILED DESCRIPTION OF THE PREFERRED EMBODIMENT

Hereinafter, a preferred embodiment in accordance with the present invention will be described with reference to the drawings.

First, a substrate transfer device in accordance with a preferred embodiment of the present invention will be explained in detail.

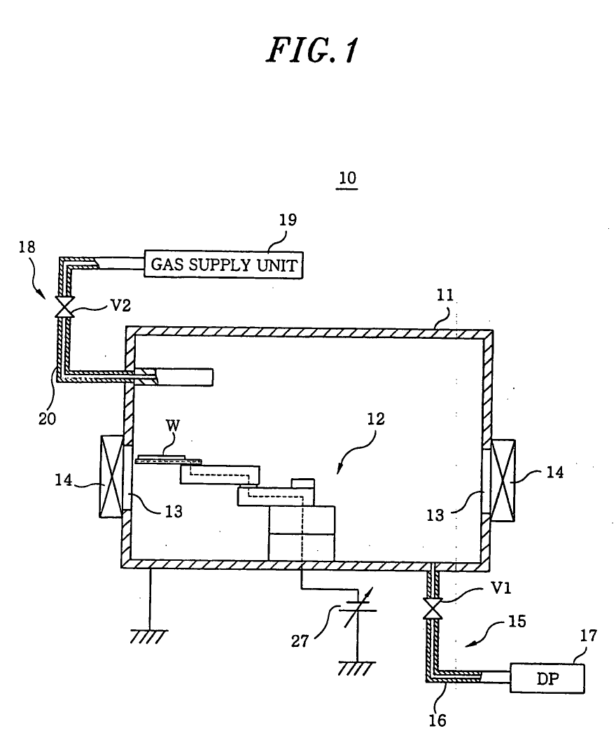

FIG. 1 shows a cross sectional view illustrating a schematic configuration of a substrate transfer device in accordance with a preferred embodiment of the present invention.

Referring to FIG. 1, a substrate transfer device 10 includes a frame-grounded box-shaped chamber (first housing chamber) 11 made of metal, e.g., aluminum or stainless steel. In the chamber 11 is installed a transfer arm (substrate transferring portion) for transferring a wafer W.

On a sidewall of the chamber 11 is located a loading/unloading port 13 for transferring the wafer W therethrough when the transfer arm 12 transfers the wafer W into or out of the chamber 11. The loading/unloading port 13 is sealed with a gate valve 14 that can be freely opened and closed. Moreover, a bottom portion of the chamber 11 is connected to a gas exhaust line (gas exhaust unit) 15. The gas exhaust line 15, which exhausts and depressurizes the chamber 11, includes a gas exhaust pipe 16 with a diameter of, e.g., 25 mm; a valve V1 installed in the middle of the gas exhaust pipe 16; and a dry pump (hereinafter, referred to as “DP”) which is a gas exhausting pump connected to the gas exhaust pipe 16. The valve V1 can shut off the DP 17 from the chamber 11. Further, a top portion of the chamber 11 is connected to a gas inlet line (gas inlet unit) 18. The gas inlet line 18 includes a gas supplying unit 19 for supplying, e.g., an N₂ gas, and a gas inlet pipe 20 for introducing the N₂ gas flowing from the gas supplying unit 19. In the middle of the gas inlet pipe 20 is installed a valve V2. The valve V2 can shut off the gas supplying unit 19 from the chamber 11.

The substrate transfer device 10 is, for example, installed in a clustered or parallel substrate processing system, and connected via a gate valve 14 to a plasma processing apparatus or the like included in the substrate processing system.

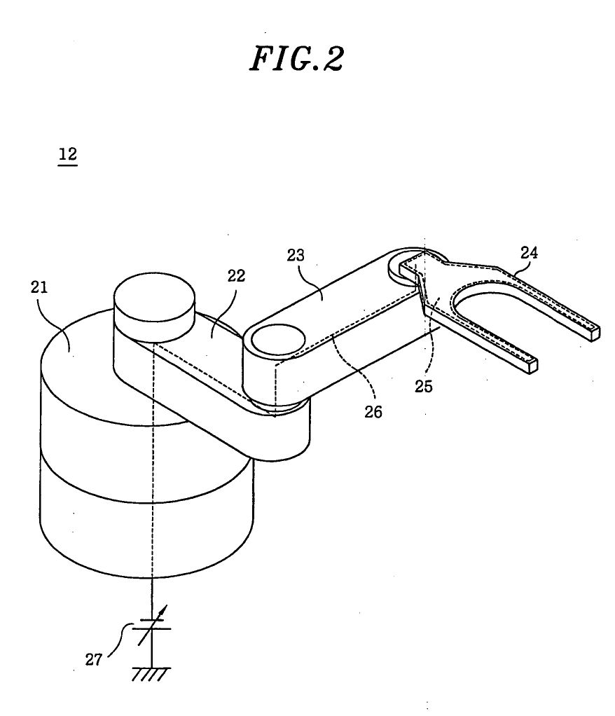

FIG. 2 presents a perspective view depicting a schematic configuration of a transfer arm of the substrate transfer device shown in the FIG. 1.

Referring FIG. 2, the transfer arm 12, which is a Scara arm type handling device, includes a rotatable table 21 located on a bottom side of the chamber 11 which can be rotated about an axis (hereinafter, referred to as “chamber's vertical axis”) vertical to the bottom side; a rod-shaped first arm member 22 connected to the rotatable table 21; a rod-shaped second arm member 23 connected to the first arm member 22; and a pick (mounting table) 24 for mounting thereon the wafer W, that is connected to one end of the second arm member 23.

In the transfer arm 12, the other end of the second arm member 23 is connected to one end of the first arm member 22 so that it can rotate about an axis vertical to the chamber, the pick 24 is connected to one end of the second arm member 23 so that it can rotate about an axis vertical to the chamber, and the rotatable table 21, the first arm member 22, the second arm member 23, and the pick 24 cooperatively rotate such that the pick 24 and the wafer W mounted on the pick 24 can be moved to a desirable position in the chamber 11, into an adjacent plasma processing apparatus through the loading/unloading port 13, or the like.

The pick 24 of the form of a tuning fork supports the wafer W at a forked part and is connected to one end of the first arm member 23 at the end opposite to the forked part. The pick 24, which is of three-layer structure, includes a lower insulation layer made of insulation material, e.g., ceramic material; an electrode layer 25 stacked on said insulation layer, formed of a conductive layer smaller than the external form of the pick 24; upper insulation layer stacked on the electrode layer 25, made of heat resistant resin, e.g., polyimide. Since the electrode layer 25 is electrically connected to a DC power supply 27 through a wire 26 distributed in the second arm member 23, the first arm member 22 and the rotatable table 21, a voltage can be applied thereto. Herein, the electrode layer 25 is interposed between the two insulation layers and, along the periphery of the pick 24, it is coated with insulation material, so that it is not exposed in the atmosphere in the chamber 11. Therefore, although the voltage is applied to the electrode layer 25, it is not short-circuited.

In the substrate transfer device 10, while the N₂ gas is being introduced into the chamber 11 through the gas inlet line 18 and the chamber is being exhausted through the gas exhaust line 15, a high voltage is applied to the electrode layer 25 of the pick 24 which has been moved to a desirable position, e.g., a vicinity of the inner surface of the chamber 11, thereby generating an electrostatic field, which in turn causes an electrostatic stress, e.g., Maxwell stress, to act on the inner surface of the chamber 11. Thus, an attaching force of the particles deposited on the inner surface of the chamber 11 becomes weaker and the particles get detached therefrom. That is, by moving the pick 24 to a desired position, the substrate transfer device 10 can peel off the particles deposited at the desired position on the inner surface of the chamber 11.

Further, since the electrostatic stress applied onto the inner surface of the chamber 11 increases as the pick 24 approaches the inner surface of the chamber 11, it is preferable to make the pick 24 approach as close as possible to the inner surface of the chamber 11 when moving the pick 24.

In addition, while the pick 24 supports the wafer W, an electrostatic field is generated between the wafer W and the pick 24, which in turn causes an electrostatic stress to act on the wafer W, so that the particles attached onto the wafer W are detached. At this time, it is preferable to arrange the electrode layer 25 in a manner to face the wafer W supported by the pick 24 to make the electrostatic stress efficiently applied onto the wafer W. The particles detached from the inner surface of the chamber 11 or the wafer W are discharged to the outside of the chamber by a viscous flow that will be described later.

However, since the pick of the transfer arm in the conventional substrate transfer device, made of insulated materials such as ceramic materials, does not have an electrode corresponding to the electrode layer 25, an electrostatic stress cannot be applied onto the surface on which the particles are deposited, so that the particles deposited on the inner surface of the chamber 11 or the wafer W cannot be removed.

To generate a sufficiently strong electrostatic stress, the magnitude of the voltage applied to the electrode layer 25 is preferably 200 V or larger, and, more preferably, between 1 to 5 kV inclusive. However, since a leak current can be generated to thereby destroy the insulation of the upper insulation layer when the applied voltage is large and the thickness or the dielectric constant of the upper electrode layer is inappropriate, the thickness and the dielectric constant of the upper electrode layer has to be set by taking the magnitude of the voltage applied to the electrode layer 25 into consideration. Further, it is also possible to set the magnitude of the voltage applied to the electrode layer 25 by taking the thickness and the dielectric constant of the upper electrode layer into consideration.

In the following, the method of cleaning the substrate transfer device that is performed in the substrate transfer device 10 will be explained, wherein the substrate transfer device is cleaned by removing the particles deposited on the inner surface of the chamber 11. Before the cleaning process corresponding to this cleaning method is performed, no voltage is applied to the electrode layer 25, the chamber 11 is depressurized by being vacuum pumped through the gas exhaust line 15, and the valve V2 is closed.

First, the pick 24 is moved to a desired position in the chamber 11 by rotating the rotatable table 21 and the like. Next, the valve V2 is opened to introduce the N₂ gas through the gas inlet line 18 to the chamber 11. Because the introduced N₂ gas is exhausted through the gas exhaust line 15, a viscous flow of the N₂ gas is generated in a direction from the ceiling portion to the bottom portion in the chamber 11.

At this time, since the viscous flow can be easily generated if the pressure in the chamber 11 is higher than a predetermined pressure, the gas exhaust line 15 exhausts the N₂ gas in the chamber 11 at such a rate that the pressure in the chamber 11 is kept not lower than, for example, 133 Pa (1 Torr), and preferably, tens of thousands of Pa (hundreds of Torr). Thus, it can be ensured to generate a viscous flow of a large viscous force.

Further, it is preferable that the flow rate of the N₂ gas being introduced into the chamber 11 is set by taking the exhausting capability of the gas exhaust line 15 into consideration; more particularly, not less than two SLM (L/min at 0° C., 101.3 kPa), and more preferably, not less than 20 SLM. The gas introduced into the chamber 11 is not limited to N₂ gas, but can also include O₂ gas or inert gas such as He, Ne, Ar, Kr, Xe or Rn gas.

In addition, to further facilitate the introduction of the N₂ gas into the chamber 11, it is preferable that an orifice structure such as a mass flow controller or a slow-up valve is not installed at a position downstream of the valve V2 in the gas inlet line 18.

Subsequently, the DC power supply 27 alternately applies high voltages of different polarities, e.g., +1 kV and −1 kV, to the electrode layer 25, thereby generating an electric field which gives rise to an electrostatic stress acting on the inner surface of the chamber 11, which in turns makes the particles be detached from the inner surface of the chamber 11. The detached particles are discharged to the outside of the chamber 11 by the above-described viscous flow.

The electrostatic stress acts on the inner surface of the chamber 11 effectively when the high voltages start to be applied to the electrode layer 25 as well as when they stop to be applied. Herein, since the high voltages are repeatedly applied to the electrode layer 25 in the substrate transfer device 10, effective electrostatic stresses act repeatedly on the inner surface of the chamber 11. Therefore, the particles deposited on the inner surface of the chamber 11 can be removed more thoroughly.

Further, if a high voltage of a same polarity is repeatedly applied to the electrode layer 25, the inner surface of the chamber 11 gets charged and thus the electrostatic stress applied onto the inner surface of the chamber 11 decreases, so that the efficiency for removing the particles deposited on the inner surface of the chamber 11 may be reduced. In the substrate transfer device 10, high voltages of different polarities are alternately applied to the electrode layer 25, so that the inner surface of the chamber 11 does not get charged, thereby preventing the efficiency for removing the particles deposited on the inner surface of the chamber 11 from being reduced.

In addition, as described above, an efficient application of the electrostatic stress is dependent on how many times the high voltages are applied to the electrode layer 25 and not much dependent on the application time during which the high voltages are applied to the electrode layer 25. Therefore, time interval during which the high voltages are applied to the electrode layer 25 may be, e.g., 1 second or less.

Furthermore, while the N₂ gas is being introduced through the gas inlet line 18 into the chamber 11, high voltages of different polarities are alternately applied to the electrode layer 25 a predetermined number of times, and thereafter both the valve V2 of the gas inlet line 18 and the valve V1 of the gas exhaust line 15 are simultaneously closed, thereby the process being completed.

In accordance with the above-described cleaning method for the substrate transfer device, while the N₂ gas is being introduced into the chamber 11 and the chamber 11 is being exhausted, high voltages of different polarities are alternately applied to the electrode layer 25 placed at the pick 24 that has been moved to a desired position in the chamber 11, so that a viscous flow is formed in the chamber 11 and an electric field is generated at the desired position in the chamber 11, that in turns makes an electrostatic stress act on the inner surface of the chamber 11 at a vicinity of the desired position, thereby making the particles deposited on the inner surface of the chamber 11 be detached therefrom. The detached particles are discharged from the chamber 11 by the viscous flow. Therefore, the deposited particles can be efficiently removed without exposing the inner surface of the chamber 11 to the outside atmosphere while maintaining the operating rate of the substrate processing system having the substrate transfer device 10.

Although the electrode layer 25 to which the high voltages are applied is placed at the pick 24 in the above-described substrate transfer device 10, the place where the electrode is placed is not limited thereto. It can be placed at any place as long as it can be moved to a desired position in the chamber 11 by the transfer arm 12. For example, it can also be placed at a vicinity of the end portion of the second arm member 23. However, by placing the electrode layer 25 at the pick 24, the wafer W can be adsorbed onto the pick 24 by electrostatic adsorptive force while the wafer W being transferred. Thus, the transferring speed of the wafer W can be increased, thereby enhancing the throughput.

Further, in case of removing the particles attached onto the wafer W, it is preferable to perform the above-described cleaning method of the substrate transfer device without mounting the wafer W onto the pick 24, thereby removing the particles deposited on the inner surface of the chamber 11 in advance. Thus, the efficiency of removing the particles attached onto the wafer W can be enhanced.

Hereinafter, a substrate processing system in accordance with a preferred embodiment of the present invention will be described in detail.

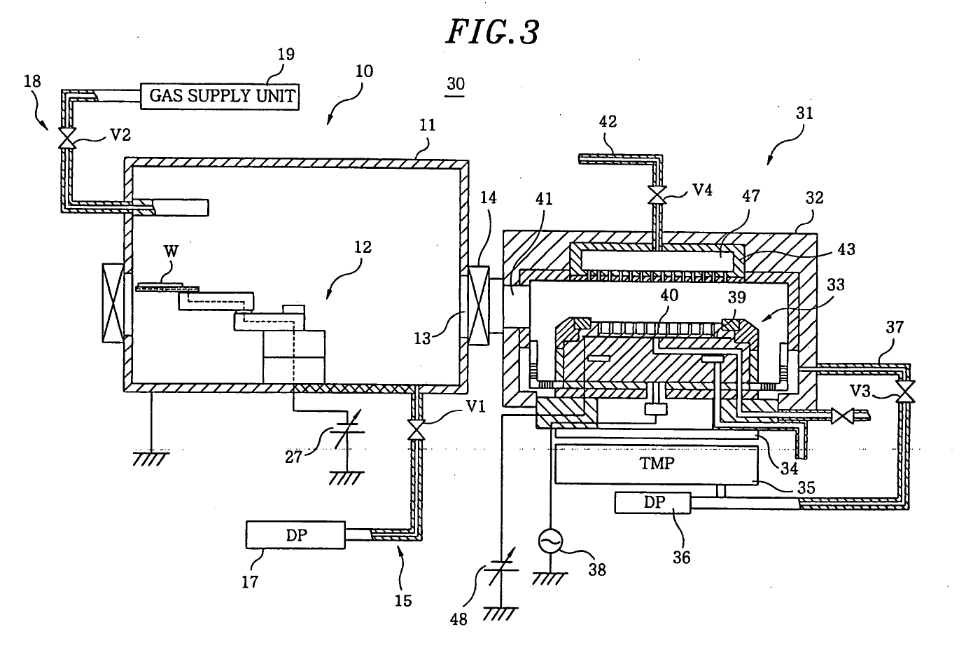

FIG. 3 provides a cross sectional view representing a schematic configuration of the substrate processing system in accordance with the preferred embodiment of the present invention.

In FIG. 3, a substrate processing system 30 includes a substrate transfer device 10 and a plasma processing apparatus 31 connected to the substrate transfer device 10 via the gate valve 14.

The plasma processing apparatus 31, configured as an etching apparatus for performing an etching process on the wafer W, includes a cylindrical chamber (second housing chamber) 32 made of metal. In the chamber 32 is placed a circular susceptor 33 on which the wafer W is mounted.

The chamber 32 is made to communicate with an automatic pressure control valve (referred to as “APT”) 34 at a lower portion of the chamber 32. The APC 34 is connected to a turbo-molecular pump 35 (referred to as a “TMP”) 35 and a DP 36 via the TMP 35. The APC 34 controls the pressure in the chamber 32, and the TMP 35 and the DP 36 depressurize the chamber 32 to a vacuum level.

Further, the chamber 32 is connected to a rough pumping line at a lower inside wall of the chamber 32. The rough pumping line includes a gas exhaust pipe 37 and a valve V3 placed in the gas exhaust pipe 37. The valve V3 can shut off the chamber 32 from the DP 36. The rough exhaust line exhausts gases in the chamber 32.

The susceptor 33 is electrically coupled to a high frequency power supply 38. Thus, the susceptor 33 functions as a lower electrode to which a high frequency power is applied.

At an upper portion in the susceptor 33 is placed an electrode plate 39 for adsorbing the wafer W with the help of an electrostatic adsorptive force. The wafer W is adsorbed to be held on the upper side of the susceptor 33 by a Coulomb force or Johnson-Rahbek's force generated by a DC current applied to the electrode plate 39 from a DC power supply 48.

At the place where the wafer W is adsorbed on the upper side of the susceptor 33 are formed thermally conductive gas supply openings 40. The thermally conductive gas supply openings 40 supply a thermally conductive gas from a thermally conductive gas supply device (not shown) via a thermally conductive gas supply line to a space between the upper side of the susceptor 33 and the backside of the wafer W.

On a sidewall of the chamber 32 is opened a loading/unloading port 41 for loading/unloading the wafer W, and the loading/unloading port 41 is closed by the gate valve 14. When the gate valve 14 is opened, the chamber 32 in the plasma processing apparatus 31 can communicate with the chamber 11 in the substrate transfer device 11.

Further, in the ceiling portion of the chamber 32 is placed a shower head 43 functioning as an upper electrode of a ground voltage. Thus, a high frequency voltage is applied from the high frequency power supply 38 between the susceptor 33 and the shower head 43. The shower head 43 in the ceiling portion is connected to a processing gas supply device (not shown) via a processing gas inlet line 42. A valve V4 is installed in the processing gas inlet line 42. The valve V4 can shut off a buffer chamber 47 from the processing gas supply device.

During the etching process in the plasma processing apparatus 31, the gate valve 14 is opened, and then the wafer W to be processed is transferred into the chamber 32 by the transfer arm 12 to be mounted onto the susceptor 33. Subsequently, the processing gas (for example, a gaseous mixture of a C₄F₈ gas, an O₂ gas and an Ar gas with a predetermined flow rate ratio) is introduced at a predetermined flow rate and a predetermined flow rate ratio into the chamber 32 through the shower head 43. Then, The pressure in the chamber 32 is controlled to be set at a predetermined level by using the APC 34 and the like. Further, the high frequency power is supplied to the susceptor 33 from the high frequency power supply 38, and a DC voltage is applied to the electrode plate 39, thereby making the wafer W be adsorbed onto the susceptor 33. Then, the processing gas injected through the shower head 43 becomes a plasma by an RF electric field formed between the susceptor 33 and the shower head 43. The radicals and ions generated from the plasma etch the surface of the wafer W.

In the plasma processing apparatus 31, a part of the plasma generated that does not converge onto the surface of the wafer W collides with such places as the inner wall of the chamber 32 to thereby generate particles. Further, residual deposits of the materials generated in the reactions by the plasma become particles. Among these particles, some particles are not exhausted through the main gas exhaust line or the rough pumping line and are deposited on the inner surface of the chamber 32 or the like. Therefore, such particles have to be removed.

In the substrate processing system 30, the chamber 11 in the substrate transfer device 10 is made to communicate with the chamber 32 in the plasma processing apparatus 31 via the loading/unloading port 13, the gate valve 14 and the loading/unloading port 41. Therefore, the transfer arm 12 can move the pick 24 to a desired position in the chamber 32 via the loading/unloading port 13, the gate valve 14 and the loading/unloading port 41.

In the plasma processing apparatus 31, while the N₂ gas is being introduced into the chamber 32 through the shower head 43 and the chamber 32 is being exhausted through the rough pumping line, a high voltage is applied to the electrode layer 25 of the pick 24 which has been moved to a desirable position, e.g., a vicinity close to an inner surface of the chamber 32, thereby making an electrostatic stress act on the inner surface of the chamber 32. Thus, attaching forces of the particles deposited on the inner surface of the chamber 32 becomes weaker and the particles get detached therefrom. Therefore, in the substrate processing system 30, by moving the pick 24 to a desired position, the particles deposited on the inner surface of the chamber 11 of the substrate transfer device 10 as well as the particles deposited on the inner surface of the chamber 32 of the substrate processing apparatus 31 can be detached to be peeled off from the surface.

In the following, there will be explained the method of cleaning the substrate processing system by removing the particles deposited on the inner surface of the chamber 11 in the substrate transfer device 10 and the particles deposited on the inner surface of the chamber 32 of the plasma processing apparatus 31. Further, because the cleaning method in case where the pick 24 is moved to a desired position in the chamber 11 of the substrate transfer device 10 is same as that described above, its explanation will be omitted. In the following will be described only the cleaning method in case where the pick 24 is moved to a desired position in the chamber 32 of the plasma processing apparatus 31.

Before the cleaning process in accordance with this cleaning method is performed, no voltage is applied to the electrode layer 25, the chamber 32 is depressurized by being vacuum pumped through the rough pumping line, and the valve V4 is closed.

First, the pick 24 is moved to a desired position in the chamber 32 by rotating the rotatable table 21 and the like. Next, the valve V4 is opened to introduce the N₂ gas through the shower head 43 into the chamber 32. Because the introduced N₂ gas is exhausted through the rough pumping line, a viscous flow of the N₂ gas is formed in a direction from the ceiling portion to the bottom portion in the chamber 32. At this time, similarly to the above-described cleaning method of the substrate transfer device, it is preferable for the rough pumping line to exhaust the N₂ gas in the chamber 32 such that the pressure in the chamber 32 is maintained to be not lower than a predetermined pressure.

Further, the flow rate and the type of the N₂ gas introduced into the chamber 32 are also same as those of the above-described cleaning method of the substrate transfer device.

Subsequently, the DC power supply 27 alternately applies high voltages of different polarities, e.g., +3 kV and −3 kV, to the electrode layer 25. At this time, an electric field is generated, which in turn causes an electrostatic stress to act on the inner surface of the chamber 32 such that the particles will be detached from the inner surface of the chamber 32. The detached particles are discharged to the outside of the chamber 11 by the above-described viscous flow. Similarly to the above-described cleaning method of the substrate transfer device, the magnitude of the high voltage applied to the electrode layer 39 is preferably between 1 and 5 kV inclusive, and the application time of the high voltage may be 1 second or shorter.

Furthermore, while the N₂ gas is being introduced through the shower head 43 into the chamber 32, high voltages of different polarities are alternately applied to the electrode layer 25 a predetermined number of times, and subsequently both the valve V4 of the shower head 43 and the valve V3 of the rough pumping line are closed simultaneously, thereby the process being completed.

In accordance with the above-described cleaning method for the substrate processing system, while the N₂ gas is being introduced into a chamber into which the pick 24 has been moved (referred to as “pick-moved chamber” afterwards) among the chamber 11 and the chamber 32, and in addition, the pick-moved chamber is being exhausted, high voltages of different polarities are alternately applied to the electrode layer 25 placed at the pick 24, so that a viscous flow is formed in the pick-moved chamber and an electric field is generated at the desired position in the pick-moved chamber to thereby make an electrostatic stress act on the inner surface of the pick-moved chamber at a vicinity of the desired position, thereby making the particles deposited on the inner surface of the chamber 11 be detached therefrom. Further, the detached particles are discharged from the chamber 11 by the viscous flow. Therefore, the deposited particles can be removed without exposing the chamber 11 and the chamber 32 to the outer environment. That is, the deposited particles can be removed sufficiently without reducing the operating rate of the substrate processing system 30.

Although the substrate transfer device 10 and the plasma processing apparatus 31 respectively include an exhaust device (the gas exhaust line 15 and the rough pumping line) in the above-described substrate processing system 30, it is also possible that the substrate transfer device 10 and the plasma processing apparatus 31 may commonly share an exhaust device. It is also possible, for example, for the gas exhaust line 15 to be connected to the DP 36.

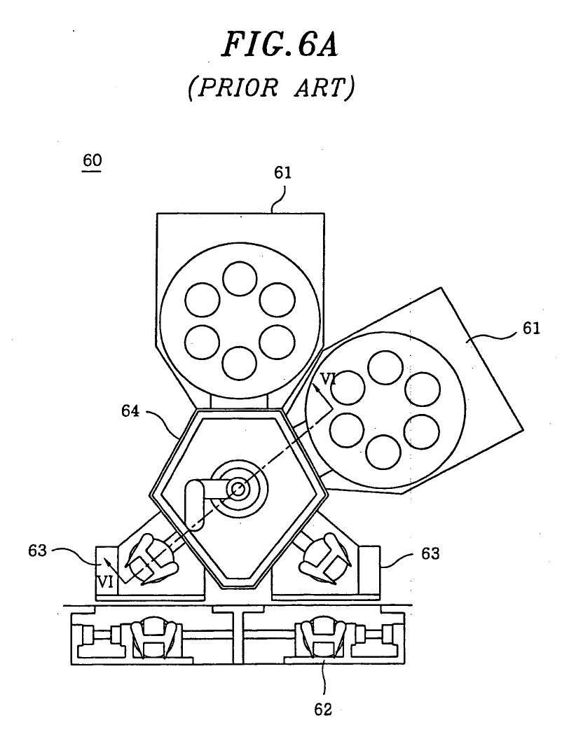

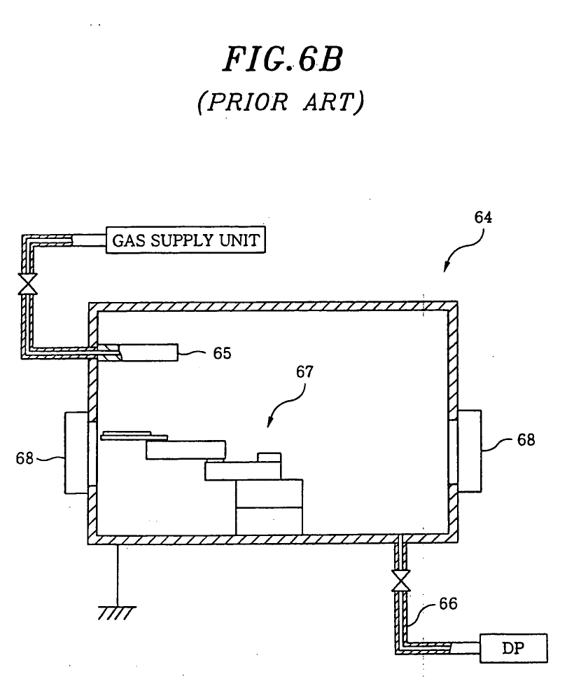

Although the plasma processing apparatus 31 is connected to the substrate transfer device 10 in the substrate processing system 30, a component apparatus in the substrate processing system that can be connected to the substrate transfer device 10 does not have to be limited thereto. The substrate transfer device 10 can be connected to any component apparatus that includes a chamber accommodating the wafer W (referred to as “an alternative chamber” afterwards), a gas inlet line for introducing the N₂ gas or the like into the alternative chamber, a gas exhaust line for exhausting the inside of the alternative chamber and an opening for making the alternative chamber communicate with the chamber 11. The substrate transfer device 10 can also be connected to, for example, a plasma processing apparatus configured as a CVD apparatus or an ashing apparatus, or the wafer loading/unloading chamber 63 shown in FIGS. 6A and 6B. The component apparatus connected to the substrate transfer device 10 can be cleaned by the above-described cleaning method of the substrate processing system so that deposited particles can be removed without exposing the alternative chamber to the outer environment.

Further, the arrangement types of the substrate transfer device 10 and the plasma processing apparatus 31 in the substrate processing system 30 do not have to be specifically limited, and either the clustered type or the parallel type can be used.

Although a Scara arm type handling device is used as the transfer arm in the substrate transfer device 10 and the substrate processing system 30, the type of the transfer arm is not limited thereto, and a frog leg type handling device can also be used.

In the following, an experimental example of the present invention will be explained in detail.

The experimental example that will be described later was performed in the above-described substrate transfer device 10.

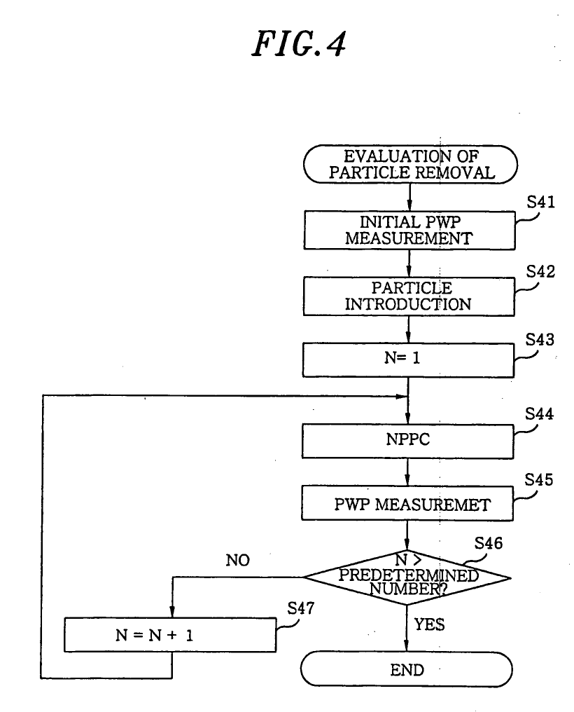

FIG. 4 offers a flow chart for an evaluation sequence of a particle removing process carried out as the experimental example of the present invention.

First, the wafer W was transferred in the chamber 11 of the substrate transfer device 10 and the number of the particles attached onto the transferred wafer W was counted, so that an initial PWP (Particles per Wafer Pass) was measured (step S41). Subsequently, the maintenance window of the substrate transfer device 10 was opened to introduce dusts in the air into the chamber 11 (step S42). Then, the maintenance window of the substrate transfer device 10 was closed and a counter in a controller (not shown) of the substrate transfer device 10 was set to be “1” (step S43). The above-described cleaning method of the substrate transfer device was performed as NPPC (Non-Plasma Particle Cleaning) (step S44). The wafer W was transferred in the chamber 11 of the substrate transfer device 10 having been cleaned by the NPPC and the number of the particles attached onto the transferred wafer W was counted, so that the PWP after cleaning was measured (step S45).

Subsequently, it was determined whether the counter N was greater than a predetermined number or not (step S46). If the counter N is equal to or smaller than the predetermined number (“NO” at step S46), the counter was incremented by 1 (step S47) and step S44 was repeated. When the counter N became greater than the predetermined number (“YES” at step S46), the process was completed.

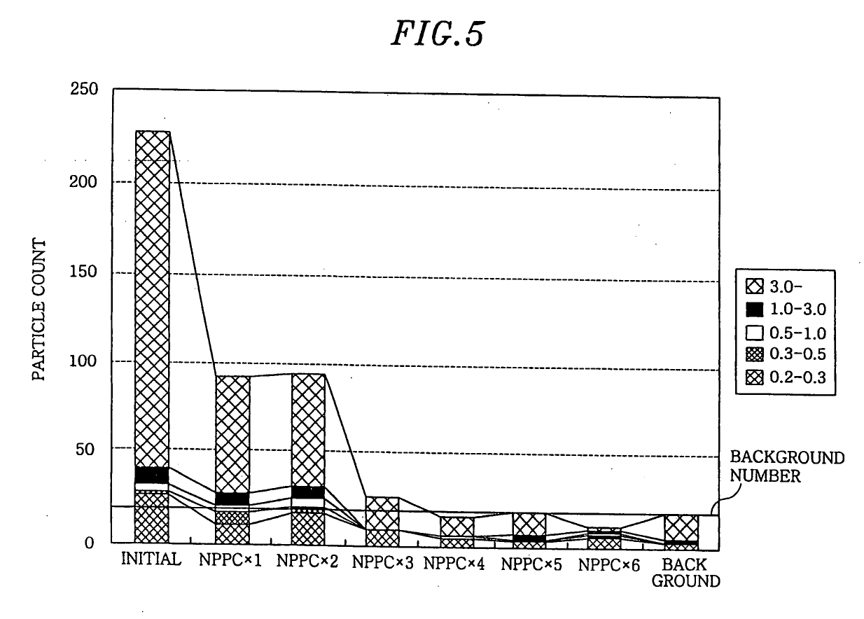

Herein, FIG. 5 illustrates a graph of the measured PWPs.

In FIG. 5, the horizontal axis represents the number of the measurement and the vertical axis represents the PWP. Further, the PWP at the right end portion of the horizontal axis represents the number of the particles (referred to as “background number” afterwards) that had already been attached onto the wafer when the wafer W was set in a cassette chamber (C/C) (not shown) connected to the substrate transfer device 10.

As shown in FIG. 5, the PWP can be greatly reduced by performing the NPPC multiple times. That is, we found that the particles deposited on the inner surface of the chamber 11 of the substrate transfer device 10 could be sufficiently removed. Further, by performing the NPPC more than three times, the PWP can be decreased to the background level. That is, we found that the particles deposited in the chamber 11 could be removed almost completely. While the NPPC was repeatedly performed, the maintenance window of the substrate transfer device 10 was kept closed. Therefore, by performing the above-described cleaning method of the substrate transfer device, the particles deposited on the inner surface of the chamber 11 can be removed without exposing the chamber 11 to the outer environment. That is, we found that the deposited particles could be sufficiently removed without reducing the operating rate of the substrate processing system 30 including the substrate transfer device 10.

While the invention has been shown and described with respect to the preferred embodiments, it will be understood by those skilled in the art that various changes and modifications may be made without departing from the spirit and scope of the invention as defined in the following claims.

What is claimed is:

1. A substrate transfer device, comprising:
an accommodating chamber for accommodating a substrate;
a substrate transfer unit installed in the accommodating chamber for transferring the substrate;
a gas exhaust unit for exhausting the accommodating chamber; and
a gas introducing unit for introducing a gas into the accommodating chamber,
wherein the substrate transfer unit has a mounting subunit for mounting the substrate thereon, an arm subunit one end of which is connected to the mounting subunit to move the mounting subunit, and an electrode installed in the mounting subunit to which a voltage is applied, and
wherein a high voltage is applied to the electrode while the gas is being introduced into the accommodating chamber and the accommodating chamber is being exhausted.

2. The substrate transfer device of claim 1, wherein the electrode is arranged in a manner to face the substrate mounted on the mounting subunit.

3. The substrate transfer device of claim 1, wherein an absolute value of the high voltage ranges between 1 to 5 kV inclusive.

4. The substrate transfer device of claim 1, wherein high voltages of different polarities are alternately applied to the electrode.

5. The substrate transfer device of claim 1, wherein a pressure in the accommodating chamber is kept at 133 Pa or above.

6. A cleaning method of a substrate transfer device for removing particles deposited on an inner surface of the accommodating chamber for accommodating a substrate in the substrate transfer device, comprising:
the moving step of moving a mounting unit for mounting thereon the substrate to a desired position in the accommodating chamber; and
the high voltage applying step of applying a high voltage to an electrode installed in the mounting unit having been moved, while a gas is being introduced into the accommodating chamber and the accommodating chamber is being exhausted.

7. A substrate processing system, comprising:
a substrate transfer device including a first accommodating chamber for accommodating a substrate and a substrate transfer unit installed in the first accommodating chamber for transferring the substrate; and
a substrate processing apparatus including a second accommodating chamber connected to the substrate transfer device for accommodating the substrate,
wherein the substrate processing system further comprises:
a gas exhaust unit for exhausting at least one of the first and the second accommodating chamber; and
a gas introduction unit for introducing a gas or gases into the exhausted one of the accommodating chambers or both of the exhausted accommodating chambers,
wherein the substrate transfer unit has a mounting subunit for mounting the substrate thereon, an arm subunit one end of which is connected to the mounting subunit to move the mounting subunit, and an electrode installed in the mounting subunit to which a voltage is applied, and
wherein a high voltage is applied to the electrode while the gas is being introduced into one of the first and the second accommodating chambers in which the mounting unit has been moved and the accommodating chambers is being exhausted.

8. A cleaning method of substrate processing system for removing particles deposited on an inner surface of the accommodating chamber or the accommodating chambers for accommodating a substrate in at least one of a substrate transfer device and a substrate processing apparatus included in the substrate processing system, comprising:
the moving step of moving a mounting unit for mounting thereon the substrate to a desired position in the accommodating chamber or the accommodating chambers in at least one of the substrate transfer device and the substrate processing apparatus; and
the high voltage applying step of applying a high voltage to an electrode installed in the mounting unit having been moved, while a gas is being introduced into the accommodating chamber and the accommodating chamber is being exhausted.
